(19) United States
(12) Patent Application Publication
(10) Pub. No.: US 2026/0245197 A1
(43) Pub. Date: Aug. 20, 2026

(54) APPARATUSES AND METHODS FOR CHARACTERIZING AN OBJECT AND APPARATUS AND METHOD FOR TRAINING A MACHINE-LEARNING MODEL

(71) Applicant: Sony Group Corporation, Tokyo (JP)

(72) Inventor: Stefan HEUSSER, Zurich (CH)

(21) Appl. No.: 19/164,185

(22) PCT Filed: Feb. 26, 2024
(86) PCT No.: PCT/EP2024/054743

§ 371 Date: Sep. 10, 2025

(30) Foreign Application Priority Data
Mar. 24, 2023 (EP) 23164119.2

(51) Int. Cl. G06T 7/00; G06V 10/75; G06V 10/82

(52) U.S. Cl. CPC G06T 7/001; G06V 10/751; G06V 10/82; G06T 2207/10016; G06T 2207/20081; G06T 2207/20084

(57) ABSTRACT

An apparatus for characterizing an object is provided. The apparatus includes interface circuitry configured to receive an image stream of an event-based vision sensor. The image stream includes a plurality of images for consecutive time instants during the capture of a surface of the object. The images of the image stream each include a plurality of image pixels indicating whether a corresponding sensor pixel of the event-based vision sensor measured an event for the respective time instant. In addition, the apparatus includes processing circuitry configured to determine the presence of a crack on the surface of the object based on the image stream.

### FIELD

The present disclosure relates to event-based object characterization. In particular, examples of the present disclosure relate to apparatuses and methods for characterizing an object as well as an apparatus and a method for training a machine-learning model.

### BACKGROUND

Cracks form and propagate as a result of material deformation caused by stresses being applied and relieved within static (e.g., structural) members. These stresses can be induced by various sources such as loading, cyclic loading and/or changes in temperature. Crack theory is an important aspect for material integrity determination in fatigue analysis.

Hence, there may be a demand for improved object characterization with respect to cracks and loading.

### SUMMARY

This demand is met by apparatuses and methods in accordance with the independent claims. Advantageous embodiments are defined by the dependent claims.

According to a first aspect, the present disclosure provides an apparatus for characterizing an object. The apparatus comprises interface circuitry configured to receive an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. In addition, the apparatus comprises processing circuitry configured to determine the presence of a crack on the surface of the object based on the image stream.

According to a second aspect, the present disclosure provides a method for characterizing an object. The method comprises receiving an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. In addition, the method comprises determining the presence of a crack on the surface of the object based on the image stream.

According to a third aspect, the present disclosure provides another apparatus for characterizing an object. The apparatus comprises interface circuitry configured to receive an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. Additionally, the apparatus comprises processing circuitry configured to determine whether a deflection of the object occurred based on the image stream. If it is determined that a deflection of the object occurred, the processing circuitry is further configured to increment a counter for counting a number of load cycles to which the object has been subjected.

According to a fourth aspect, the present disclosure provides another method for characterizing an object. The method comprises receiving an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. Additionally, the method comprises determining whether a deflection of the object occurred based on the image stream. If it is determined that a deflection of the object occurred, the method further comprises incrementing a counter for counting a number of load cycles to which the object has been subjected.

According to a fifth aspect, the present disclosure provides an apparatus for training a machine-learning model for predicting a development of a crack on a surface of an object and a failure of the object. The apparatus comprises processing circuitry configured to determine, based on an image stream of an event-based vision sensor, a characteristic describing the development of the crack for a time instant. In addition, the processing circuitry is configured to determine a difference between the determined characteristic and a prediction of the machine-learning model about the development of the crack for the time instant. The processing circuitry is configured to determine a reward according to a reward function based on the determined difference. Further, the processing circuitry is configured to modify the machine-learning model based on the determined reward to maximize the reward.

According to a sixth aspect, the present disclosure provides a method for training a machine-learning model for predicting a development of a crack on a surface of an object and a failure of the object. The method comprises determining, based on an image stream of an event-based vision sensor, a characteristic describing the development of the crack for a time instant. In addition, the method comprises determining a difference between the determined characteristic and a prediction of the machine-learning model about the development of the crack for the time instant. The method comprises determining a reward according to a reward function based on the determined difference. Further, the method comprises modifying the machine-learning model based on the determined reward to maximize the reward.

According to a seventh aspect, the present disclosure provides a non-transitory machine-readable medium having stored thereon a program having a program code for performing the method according to the second, the fourth or the sixth aspect, when the program is executed on a processor or a programmable hardware.

According to an eighth aspect, the present disclosure provides a program having a program code for performing the method according to the second, the fourth or the sixth aspect, when the program is executed on a processor or a programmable hardware.

### BRIEF DESCRIPTION OF THE FIGURES

Some examples of apparatuses and/or methods will be described in the following by way of example only, and with reference to the accompanying figures, in which

FIG. 1 schematically illustrates a first example of an apparatus for characterizing an object;

FIG. 2 illustrates a series of images depicting exemplary crack growth;

FIG. 3 schematically illustrates a second example of an apparatus for characterizing an object;

FIG. 4 illustrates images depicting exemplary crack growth in different dimensions;

FIG. 5 illustrates a series of images depicting exemplary loading of an object;

FIG. 6 schematically illustrates a first exemplary data flow for object characterization;

FIG. 7 schematically illustrates a second exemplary data flow for object characterization;

FIG. 8 illustrates a flowchart of a first example of a method for characterizing an object;

FIG. 9 schematically illustrates a third example of an apparatus for characterizing an object;

FIG. 10 illustrates a flowchart of a second example of a method for characterizing an object;

FIG. 11 schematically illustrates an example of an apparatus for training a machine-learning model; and

FIG. 12 illustrates a flowchart of an example of a method for training a machine-learning model.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

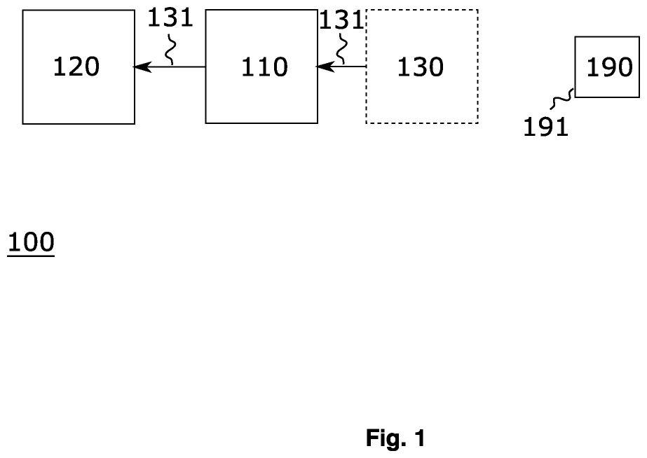

FIG. 1 schematically illustrates an exemplary apparatus 100 for characterizing an object 190. The object 190 may be any physical object (body) and may be defined as a collection of matter within a defined contiguous boundary in three-dimensional space. The surface 191 of the object 190 is the object 190's exterior or upper boundary. For example, the object 190 may be a structural element of a building, a bridge, etc. such as a beam or a pillar. However, it is to be noted that the present disclosure is not limited to the foregoing examples.

The apparatus 100 comprises at least interface circuitry 110 and processing circuitry 120. The processing circuitry 120 is coupled to the interface circuitry 110.

The interface circuitry 110 is configured to receive an image stream 131 of an event-based vision sensor 130. The event-based vision sensor 130 captures the object 190. Accordingly, the image stream 131 comprises a plurality of images for consecutive time instants during the capture of the objects surface 191. The consecutive time instants of the images included in the image stream 131 may, e.g., be determined by a clock of the event-based vision sensor 130. The event-based vision sensor 130 may capture the object's surface 191 at various angles. In particular, the event-based vision sensor 130 may be configured to capture the surface 191 of the object 190 at an angle of 90°.

The event-based vision sensor 130 is a sensor such as a dynamic vision sensor (also known as event camera, neuromorphic camera or silicon retina) that responds to local changes in brightness. The event-based vision sensor 130 does not capture image frames using a shutter like a conventional image sensor does. Instead, the photo-sensitive sensor elements or pixels (physical pixels) of the event-based vision sensor 130 operate independently and asynchronously, detecting changes in brightness as they occur, and staying silent otherwise. The event-based vision sensor 130 may be sensitive to light of different wavelengths. For example, the event-based vision sensor 130 may be sensitive to at least one of ultraviolet light, visible light and infrared light. The detection (of an occurrence) of a change in brightness by the event-based vision sensor 130 is called an “event”. Accordingly, the output of a pixel for an event may comprise data indicating that a change in brightness was measured (detected) by the pixel (optionally further indicating a polarity of the change in brightness, i.e., whether the brightness increased or decreased), data on the pixel position (i.e., the coordinates of the physical pixel) and data on the measurement (detection) time of the event such as a timestamp. The event-based vision sensor 120 may provide high temporal resolution, high (wide) dynamic range, avoid under/overexposure and avoid motion blur compared to frame-based image sensors.

The events detected by the event-based vision sensor 130 for a given time instant are output by the event-based vision sensor 130 as an image comprising a plurality of image pixels indicating whether the corresponding (physical) sensor pixel of the event-based vision sensor 130 measured an event for the time instant. Each pixel in the image corresponds to a (physical) sensor pixel of the event-based vision sensor 130. Each pixel of the event-based vision sensor 130 captures a part of the Field-of-View (FoV) of the event-based vision sensor 130 and generates a corresponding output in case an event is detected in the respective part of the event-based vision sensor's FoV. The outputs of the event-based vision sensor 130's pixels for a time instant are represented by the pixels in the resulting image.

As the pixels of event-based vision sensor 130's pixels operate independently and asynchronously, the pixels may detect events at higher rates than the frame rate of the image stream. Accordingly, the event-based vision sensor 130 may be configured to represent events detected in a time window, which includes a given time instant, as events detected at the time instant. For example, for a time instant tᵢ, the events detected in the time window [tᵢ−Δt; tᵢ+Δt] by the event-based vision sensor's pixels may be represented by pixels in the image for the time instant tᵢ as events detected at the time instant tᵢ.

The pixels in an image of the image stream 131 may be understood as Boolean objects as they can take only two possible values. The first possible value indicates that no event was detected for a given time instant (i.e., no change in brightness was measured by the corresponding physical pixel of the event-based vision sensor 130). The second possible value indicates that an event was detected for a given time instant (i.e., a change in brightness was measured by the corresponding physical pixel of the event-based vision sensor 130).

Summarizing the above, the image stream 131 comprises a plurality of images for consecutive time instants during the capture of the object's surface 191, wherein the images of the image stream 131 each comprise a plurality of image pixels indicating whether a corresponding sensor pixel of the event-based vision sensor 130 measured an event for the respective time instant. Each image of the image stream 131 is provided with (comprises) a respective timestamp denoting the respective time instant depicted by the image.

According to examples of the present disclosure, the apparatus 100 may comprise the event-based vision sensor 130. However, the present disclosure is not limited thereto. Therefore, in other examples, the event-based vision sensor 130 may be separate from (external to) the apparatus 100.

The processing circuitry 120 is configured to receive and further process the image stream 131 of the event-based vision sensor 130. For example, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be coupled to memory, e.g., read only memory (ROM) for storing software, random access memory (RAM) and/or non-volatile memory. For example, the apparatus 100 may comprise memory configured to store instructions, which when executed by the processing circuitry 120, cause the processing circuitry 120 to perform the steps and methods described herein.

The processing circuitry 120 is configured to determine the presence of a crack on the surface 191 of the object 190 based on the image stream 131. A crack is a discontinuity in the material of the object 190 that starts to grow from an initiation point. The growth of a crack causes a change in reflectivity of the object's surface 191. Accordingly, the event-based vision sensor 130 will measure a change in brightness upon formation of a crack on the surface 191. In other words, the formation of the crack will trigger the measurement of events by the event-based vision sensor 130. Hence, the image stream 131 of the event-based vision sensor 130 allows to determine the presence of a crack on the on the surface 191 of the object 190.

Unlike existing solutions such as shutter camera or X-ray based systems, the apparatus 100 may allow substantially real-time monitoring of the object 190 due to the extremely high detection rate of the event-based vision sensor 130. State-of-the art event-based vision sensors allow capture of events at rates up to 200 kHz (i.e., up to 200,000 events per second) and, hence, allow monitoring of crack growth substantially in real time. Furthermore, the apparatus 100 may allow monitoring of occluding cracks. For example, if the object 190 is subject to cyclic loading at high frequency, the object 190 is stressed and deflects. Upon deflection, a microscopic or macroscopic crack forms on the surface 191 of the object (e.g., the crack may follow a crystalline structure of the object 190's material). When the load is released and the object 190 elastically returns to its initial position, at which point the material, which was separated during the loading crack, now rejoins perfectly to its mating half, as in a puzzle piece. Detection rates of existing solutions such as shutter camera or X-ray based systems are way too low to detect such occluding cracks. However, the unprecedented detection rates of the event-based vision sensor 130 allow the apparatus 100 to also detect and optionally further analyze such cracks.

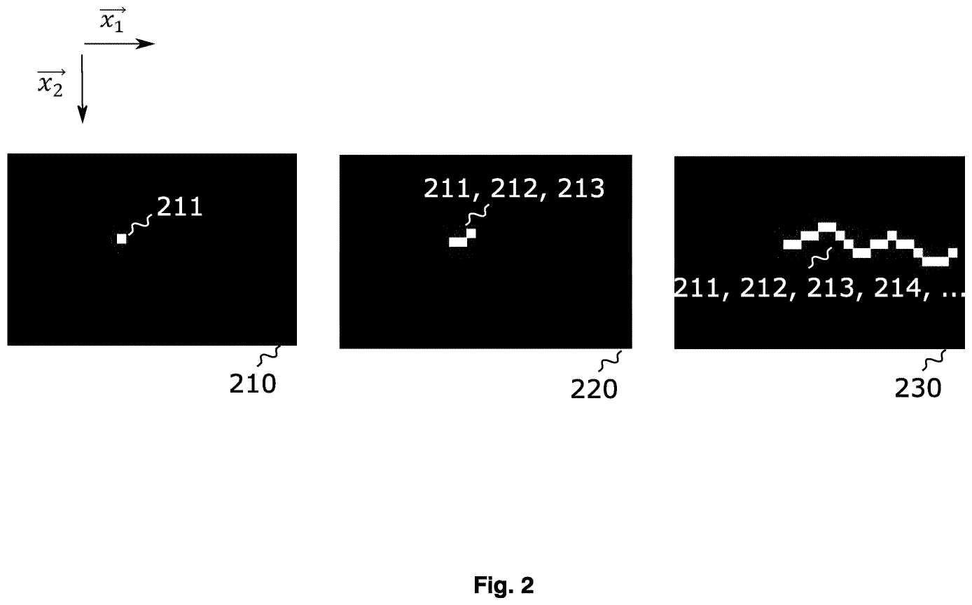

A crack's length and depth greatly exceed the width, and the crack growth generally occurs along the length. The processing circuitry 120 may be configured to determine that a crack is present on the surface 191 of the object 190 if an image of the image stream 131 comprises a pattern of pixels (which indicate measurement of a respective event by the corresponding sensor pixels) matching the structural characteristics of a crack. For example, the processing circuitry 120 may be configured to determine that a crack is present on the surface 191 of the object 190 if an image of the image stream 131 comprises a plurality of pixels which succeed each other along a spatial direction and which indicate measurement of a respective event by the corresponding sensor pixels. FIG. 2 illustrates three images 210, 220 and 230 of the image stream 131 for consecutive time instants t₁, t₂ and t₃. The images 210, 220 and 230 depict an exemplary crack growth.

At the time instant t₁, the crack starts to form on the surface 191 of the object 190 due to the object 190 being subject to, e.g., loading. The corresponding initiation point of the crack (i.e., the point on the surface 191 from which the crack starts to grow) is depicted in the image 210 for the time instant t₁. Due to the initiation of the crack, one of the event-based vision sensor 130's pixels measures a change in brightness for the time instant t₁ such that the image 210 comprises a corresponding pixel 211 indicating measurement of an event by the sensor pixel. As the crack continuous to grow, more and more of the event-based vision sensor 130's pixels measure a change in brightness. This is illustrated in FIG. 2 by the image 220 for the next time instant t₂, in which three pixels 211, 212 and 213 indicate measurement of a respective event by the corresponding sensor pixel, and the image 230 for the next but one time instant t₃, in which twenty pixels 211, 212, 213, 214, ... indicate measurement of a respective event by the corresponding sensor pixel.

As is evident from the images 210, 220 and 230, the pixels indicating measurement of a respective event by the corresponding sensor pixels succeed each other along the spatial direction \vec{x₁}. In other words, there is a continuous line of pixels along the spatial direction \vec{x₁}, which indicate measurement of a respective event by the corresponding sensor pixels in the images 210, 220 and 230. As illustrated in FIG. 2, the pixel positions of the pixels indicating measurement of a respective event by the corresponding sensor pixels may change in a spatial direction \vec{x₂}, which is perpendicular to the spatial direction \vec{x₁}.

The processing circuitry 120 may use various criteria or techniques for determining that an image comprises pixels representing a crack on the surface 191 of the object 190. For example, the processing circuitry 120 determines that a crack is present on the surface 191 of the object 190 if an image of the image stream 131 comprises a predetermined number of pixels (e.g., three, four, five, . . . ) which succeed each other along a spatial direction (e.g., the spatial direction \vec{x₁}) and which indicate measurement of a respective event by the corresponding sensor pixels. For example, the predetermined number may be three. In the example of FIG. 2, the image 210 comprises only one pixel 211 indicating measurement of a respective event by the corresponding sensor pixel, which does not yet allow the processing circuitry 120 to determine that a crack is present on the surface 191 of the object 190. The image 210 comprises three succeeding pixels 211, 212 and 213 indicating measurement of a respective event by the corresponding sensor pixels. According to the above criterion, the processing circuitry 120 may, hence, determine from the image 220 that a crack is present on the surface 191 of the object 190.

Instead of determining the presence of a crack on the surface 191 of the object 190 based on continuously connected pixels as described above, the processing circuitry 120 may base the determination of the presence of a crack on the surface 191 of the object 190 on other techniques such as computer-vision methods (algorithms) and corresponding libraries such as OpenCV.

If it is determined from the image stream 131 that a crack is present on the surface 191 of the object 190, the processing circuitry 120 may optionally be configured to further determine characteristics of the crack. The characteristics may be manifold. The determination of some exemplary characteristics will be described in the following. It is to be noted that the present disclosure is not limited thereto. More or other characteristics of the crack may be determined according to further examples of the present disclosure.

For example, the processing circuitry 120 may be configured to determine a time of occurrence of an initiation point of the crack based on the image stream 131. As described above, the initiation point of the crack is the point on the surface 191 from which the crack starts to grow. The time of occurrence of the crack's initiation point is an interesting characteristic as it may allow to correlate the formation of the crack with actions potentially causing the crack. For example, if it is determined that the time of occurrence of the crack's initiation point is tᵢₙᵢₜ and it is known that the object was subjected to stress or load at a time instant tₛₜᵣₑₛₛ, the comparison of the time instants tᵢₙᵢₜ and tₛₜᵣₑₛₛmay allow determination of whether the stress or load caused the formation of the crack. The time of occurrence of the crack's initiation point may be used for various other applications such as modelling the crack and/or the object 190. The time of occurrence of the crack's initiation point may be determined in various ways based on the image stream 131. A specific, non-limiting example will be described in the following.

For determining the time of occurrence of the initiation point of the crack, the processing circuitry 120 may, e.g., be configured to determine a plurality of pixel positions representing the crack in the first image of the image stream for which it is determined that a crack is present on the surface of the object. In the example of FIG. 2, the image 220 is the first image of the image stream 131 for which it is determined that a crack is present on the surface 191 of the object 190. Accordingly, the pixel positions of the pixels 211, 212 and 213 are determined to be pixel positions representing the crack.

Furthermore, the processing circuitry 120 may be configured to determine one or more images preceding the first image in the image stream and depicting the crack. An image pre-ceding the first image in the image stream is determined to depict the crack if the image comprises, for at least one of the plurality of determined pixel positions representing the crack, a respective pixel indicating measurement of a respective event by the corresponding sensor pixel. Referring back to the example of FIG. 2, the image 210 precedes the image 220 in the image stream 131. The image 210 comprises, like the image 220, at the pixel position of the pixel 211 a pixel representing measurement of an event by the corresponding sensor pixel of the event-based vision sensor 130. Accordingly, it is determined that the image 210 depicts the crack.

The processing circuitry 120 may additionally be configured to select the image having the earliest timestamp from the determined one or more images preceding the first image in the image stream 131 and depicting the crack. In the example of FIG. 2, only the image 210 precedes the image 220 in the image stream 131. Accordingly, it is determined that the image 210 has the earliest timestamp.

In addition, the processing circuitry 120 may be configured to determine the time indicated by the timestamp of the selected image as the time of occurrence of the initiation point of the crack. That is, the time indicated by the timestamp of the image 210 is determined as the time of occurrence of the initiation point of the crack in the example of FIG. 2.

In the above example, the processing circuitry 120 substantially goes back the image stream 131 to the image in which the first pixel was triggered by the crack to ascertain the (exact) time of the crack's initiation point.

Alternatively or in addition to the time of occurrence of the crack's initiation point, the processing circuitry 120 may be configured to determine a location (position) of the initiation point on the surface 191 based on the image stream 131. Also the location of the crack's initiation point is an interesting characteristic as it may allow one to gain insights on the object 190's reaction to stress or loading. In particular, the location of the crack's initiation point may allow one to learn about the propagation of stress or loading applied to the object 190 within the object 190. The location of the crack's initiation point on the surface 191 may be determined in various ways based on the image stream 131. A specific, non-limiting example will be described in the following.

For determining the location of the initiation point of the crack on the surface, the first three steps may be identical to the above-described determination of the time of occurrence of the crack's initiation point. That is, the processing circuitry 120 may be configured to determine a plurality of pixel positions representing the crack in the first image of the image stream 131 for which it is determined that a crack is present on the surface 191 of the object 190. Additionally, the processing circuitry 120 may be configured to determine one or more images preceding the first image in the image stream 131 and depicting the crack, and to select the image having the earliest timestamp from the determined one or more images preceding the first image in the image stream 131 and depicting the crack. Analogously to what is described above, an image preceding the first image in the image stream 131 may be determined to depict the crack if the image comprises, for at least one of the plurality of determined pixel positions representing the crack, a respective pixel indicating measurement of a respective event by the corresponding sensor pixel of the event-based vision sensor 130. In the example of FIG. 2, the image 210 is determined as the image having the earliest timestamp and depicting the crack.

Then, the processing circuitry 120 may be configured to determine the one or more pixel positions of the plurality of determined pixel positions representing the crack for which the selected image comprises a respective pixel indicating measurement of a respective event by the corresponding sensor pixel as pixel positions representing the initiation point of the crack on the surface. Referring back to the example of FIG. 2, the pixel positions 211, 212 and 213 are determined to represent the crack from the image 220. The image 210 comprises, like the image 220, at the pixel position of the pixel 211 a pixel representing measurement of an event by the corresponding sensor pixel of the event-based vision sensor 130. Accordingly, the pixel position of the pixel 211 is determined as pixel position representing the initiation point of the crack on the surface.

The processing circuitry 120 may further be configured to determine a location of the surface 191 represented by the one or more pixel positions representing the initiation point of the crack on the surface 191 as the location of the initiation point of the crack on the surface 191. That is, in the example of FIG. 2, the location of the object's surface 191 represented by the pixel 211 is determined to be the location of the crack's initiation point.

In the above example, the processing circuitry 120 substantially goes back the image stream 131 to the image in which the first pixel was triggered by the crack to ascertain the (exact) location of the crack's initiation point.

Analogously to what is described above, an image succeeding (following) the first image in the image stream 131 (for which it is determined that the crack is present on the surface 191 of the object 190) may, e.g., be determined to depict the crack if the image comprises, for at least one of the plurality of determined pixel positions representing the crack in the first image, a respective pixel indicating measurement of a respective event by the corresponding sensor pixel.

In some examples, the processing circuitry 120 may be configured to determine dimensions of the crack based on the image stream 131. If an image of the image stream 131 is determined to depict the crack, the pixel positions of the pixels depicting the crack in this image allow determination of the dimensions of the crack in two dimensions for the time instant of the image. For example, the extension of the crack in one or more spatial directions may be expressed as a respective pixel count denoting the extension of the crack along the respective spatial direction in pixels of the image. The respective pixel count may be mapped to a respective dimensional value (e.g., micrometer, millimeter or centimeter) for the respective spatial direction according to standard processes familiar to a person skilled in the art. The dimensions of the crack may be determined for each image of the image stream 131 for which it is determined that it depicts the crack. Accordingly, the development of the crack (e.g., growth or shrinking) may be monitored.

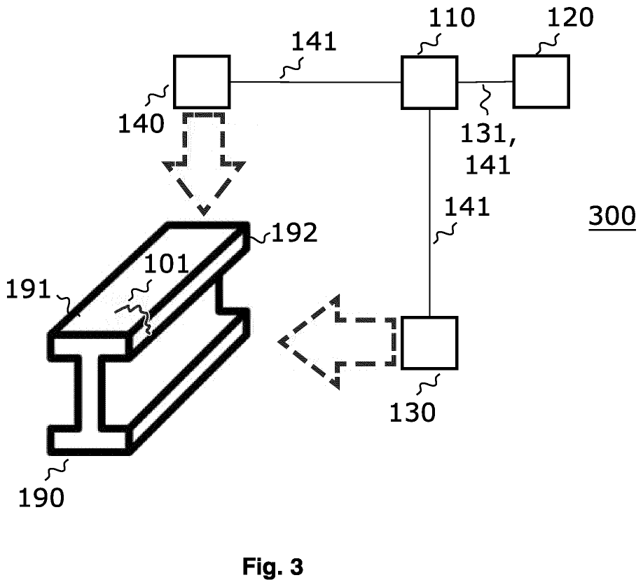

The dimensions of the crack may further be determined for multiple image planes. For example, a second event-based vision sensor may be used to capture the object 190. This is exemplarily illustrated in FIG. 3 by means of an exemplary apparatus 300 for characterizing the object 190. FIG. 3 illustrates an I-beam (also known as double-T beam) as an example for the object 190. A crack 101 formed on the surfaces 191 and 192 of the object 190.

Further illustrated is the event-based vision sensor 130 as described above. The event-based vision sensor 130 captures the surface 191 of the object 190 as described above. The event-based vision sensor 130 captures the top surface 191 of the object 190 at an angle of 90°. Further illustrated in FIG. 3 is another (a second) event-based vision sensor 140. The second event-based vision sensor 140 operates as described above for the first event-based vision sensor 130. Also the second event-based vision sensor 140 captures the object 190. The event-based vision sensor 130 and the second event-based vision sensor 140 are configured to capture the object 190 from different directions. Accordingly, the second event-based vision sensor 140 is configured to capture the side surface 192 of the object 190. The second event-based vision sensor 130 captures the surface 192 of the object 190 at an angle of 90°. In the example of FIG. 3, the event-based vision sensor 130 and the second event-based vision sensor 140 capture the object 190 from orthogonal directions. However, the present disclosure is not limited thereto. Any other arrangement of the event-based vision sensor 130 and 140 may be used as well.

Analogously to what is described above, the apparatus 300 illustrated in FIG. 3 may comprise the event-based vision sensors 130 and 140 according to examples of the present disclosure. However, the present disclosure is not limited thereto. Therefore, in other examples, one or both of the event-based vision sensors 130 and 140 may be separate from (external to) the apparatus 300.

In addition to the image stream 131 of the event-based vision sensor 130, the interface circuitry 110 is further configured to receive another (second) image stream 141 of the second event-based vision sensor 140. The second image stream 141 comprises a plurality of images for consecutive time instants during the capture of the object 190 by the second event-based vision sensor 140. Analogously to what is described above for the first image stream 131, the images of the second image stream 141 each comprise a plurality of image pixels indicating whether a corresponding sensor pixel of the second event-based vision sensor 140 measured an event for the respective time instant.

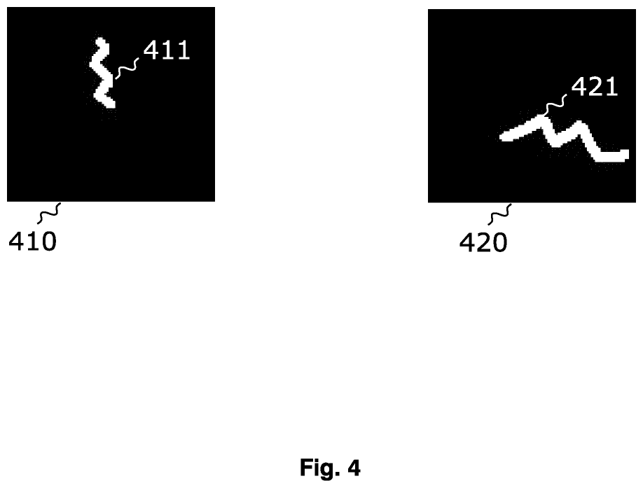

FIG. 4 illustrates an exemplary image 410 of the image stream 131 and an exemplary image 420 of the second image stream 141. Each of the images 410 and 420 comprise a plurality of image pixels 411, 421 which succeed each other along a respective spatial direction and which indicate measurement of a respective event by the corresponding sensor pixels. The groups of pixels 411 and 421 represent the crack 101. The images 420 and 430 depict the crack 101 in different planes defined by the image plane of the respective event-based vision sensor 130, 140.

Returning back to FIG. 3, the processing circuitry 110 receives the image stream 131 of the event-based vision sensor 130 from the interface circuitry 110 and processes it (e.g., as described above and/or below). Further, the processing circuitry 110 receives the image stream 141 of the second event-based vision sensor 140 from the interface circuitry 110 and processes it. The processing circuitry 110 may process the image stream 141 of the second event-based vision sensor 140 analogously to what is described herein for the processing of the image stream 131 of the event-based vision sensor 130.

For example, the processing circuitry 120 may be configured to determine the dimensions of the crack in a first plane based on the image stream 131 as described above. The first plane is defined by the image plane of the event-based vision sensor 130. The processing circuitry 120 may be further configured to determine dimensions of the crack in a second plane based on the image stream 141 of the second event-based vision sensor 140 (analogous to what is described above for the first image stream 131). The second plane is defined by the image plane of the event-based vision sensor 140. For example, the first plane and the second plane may be orthogonal as the event-based vision sensor 130 and the second event-based vision sensor 140 capture the object 190 from orthogonal directions in the example of FIG. 3. However, the present disclosure is not limited thereto. As the event-based vision sensor 130 and 140 need not be arranged orthogonal with respect to each other, also the first and the second plane need not be orthogonal to each other. That is, the first plane is different from the second plane. The determination of the dimensions of the crack in the respective plane may be as described above.

The processing circuitry 120 may further be configured to determine three-dimensional dimensions of the crack based on the determined dimensions of the crack in the first plane and the second plane. Accordingly, a three-dimensional representation of the crack may be obtained. For example, the coordinates of the crack in the first plane and the coordinates of the crack in the second plane may be mapped to a three-dimensional coordinate system such as a Euclidean coordinate system using one or more coordinate transformations.

In the example of FIG. 3 and FIG. 4, two event-based vision sensors are arranged orthogonal to each other and perpendicular to the stressed member. As each event-based vision sensor can detect two dimensions, using a second event-based vision sensors allows a third dimension to be monitored. The object illustrated in FIG. 3 is monitored from two directions, the first event-based vision observes the object in the XZ plane, while the second event-based vision (placed orthogonally) observes the XY plane, thus the apparatus can monitor the I-beam in three dimensions. The event-based vision sensors may, e.g., be fixed to an absolute reference point, independent from the deflection of the object.

The processing circuitry 120 may optionally be further configured to determine whether the crack is growing (or shrinking) based on a comparison of images of the image stream 131. For example, the pixel positions of the pixels depicting the crack in the respective image may be compared for consecutive images to determine whether the crack is growing (or shrinking). In other examples, the respective dimensions of the crack determined for consecutive images may be compared to determine whether the crack is growing (or shrinking).

In many cases, a crack is only growing if the object 190 is subjected to a load cycle. Accordingly, if it is determined that the crack is growing, the processing circuitry 120 may further be configured to increment a counter for counting a number of load cycles to which the object 190 has been subjected. The number of load cycles to which the object 190 has been subjected is a quantity that may allow to predict the failure of the object (further details about failure prediction will be described later). If it is determined that no deflection of the object occurred, the counter is not incremented.

In other words, once the crack initiation point has been the detected, the crack may be monitored, e.g., at high frequency over several time steps. The moment the crack begins to grow, the sensor pixels of the event-based vision sensor 130 will detect this “event” and count it as a load cycle.

However, the present disclosure is not limited to determining that the object 190 has been subjected a load cycle based on the presence of a crack. In some examples, the processing circuitry 120 may be configured to determine whether a deflection (deformation) of the object 190 occurred based on the image stream 131 independently from the determination of whether a crack is present. The deflection of the object temporarily changes the position and/or the shape of the object 190. The change of the position and/or the shape of the object causes a change in reflectivity in parts of the event-based vision sensor's FoV. Accordingly, the event-based vision sensor 130 will measure a change in brightness upon deflection of the object 190. In other words, the deflection of the object 190 will trigger the measurement of events by the event-based vision sensor 130. Hence, the image stream 131 of the event-based vision sensor 130 allows to determine whether a deflection (deformation) of the object 190 occurred.

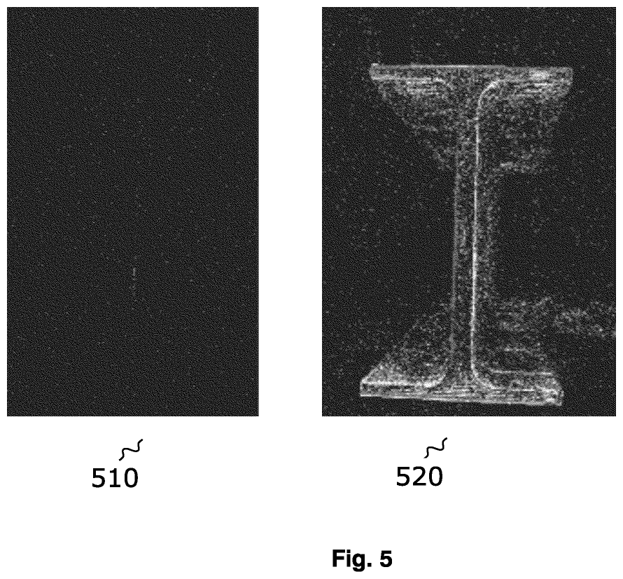

This is exemplarily illustrated in FIG. 5. FIG. 5 illustrates two consecutive images 510 and 520 of the image stream 131. In the example of FIG. 5, the object 190 is again an I-beam. The image 510 is captured by the event-based vision sensor 130 while the object 190 is static, i.e., not subject to loading. Accordingly, the image 510 does not comprise pixels indicating measurement of a respective event by the corresponding sensor pixels (except for noise-induced events). The image 510 is captured by the event-based vision sensor 130 while the object 190 is subject to loading. Accordingly, the image 510 comprises pixels indicating measurement of a respective event by the corresponding sensor pixels. The pixels indicating measurement of a respective event by the corresponding sensor pixels in the image 510 replicate substantially the shape of the object 190. Accordingly, the processing circuitry 120 may base the determination of whether a deflection of the object 190 occurred on techniques such as computer-vision methods (algorithms) and corresponding libraries such as OpenCV that allow to recognize the shape of the object 190 in an image of the image stream 131.

Due to the extremely high detection rate of the event-based vision sensor 130, the apparatus 100 may allow substantially real-time monitoring of the object's deflection. In particular, the apparatus 100 may allow to reliably determine deflections of the object 190 in case the object 190 is subject to cyclic loading at high frequency.

As described above, a substantial deflection of the object 190 only occurs if the object 190 is subjected to a load cycle. Accordingly, if it is determined that a deflection of the object 190 occurred, the processing circuitry 120 may be further configured to increment a counter for counting a number of load cycles to which the object 190 has been subjected. As described above, the number of load cycles to which the object 190 has been subjected is a quantity that may allow to predict the failure of the object (further details about failure prediction will be described later).

In other words, by placing the event-based vision sensor 130, e.g., perpendicular to the load, the deflection of the stressed object 190 can be measured. As the member begins to deflect, the event-based vision sensor 130 detects this as an “event” and a load cycle can be counted. The load counting based on the deflection of the object 190 may be performed independently from the crack monitoring.

As each load cycle directly effects the integrity of the structural element, it is desirable to count each load cycle. As loading situations can vary and need not be rhythmic or symmetric, the apparatus 100 allows to measure deflections and stress states on a case-by case basis using the method of loading counting. For example, the load counting may be used for an object such as a structural element which is loaded at random intervals at random forces. In other examples, the object 190 may be a member which is stressed by an external load, but this load is not removed, instead the stress induced to the member is relieved though other stress relieving mechanics such as material crystalline structure reconfiguration, temperature compensation, buckling or plastic deformation. These cases do not have a symmetrical loading cycle as in loading in the elastic region of the stressed member. In this case a conventional device to measure vibrations would not accurately capture this loading event. Hence, the apparatus 100 counts loading events independent of amplitude or frequency and does not require bidirectional loading.

The processing circuitry 120 may optionally further determine one or more characteristics of the deflection. A specific, non-limiting example will be described in the following. The processing circuitry 120 may, e.g., be configured to determine a duration (length) of the deflection. For example, the processing circuitry 120 may be configured to select the image of the image steam 131 having the earliest timestamp from a plurality of images identified as images representing the deformation. Additionally, the processing circuitry 120 may be configured to select the image of the image steam 131 having the latest timestamp from the plurality of images identified as images representing the deformation. Whether an image of the image stream 131 represents the deformation may be determined as described above. The processing circuitry 120 may be configured to determine the difference between the image having the latest timestamp and the image having the earliest timestamp as the duration of the deflection. The duration of the deflection may allow learning about the reaction of the object 190 to the loading and may further allow characterization of the loading process.

In other words, once the crack initiation point has been the detected, the crack is monitored at high frequency over several time steps. The moment the crack begins to grow, the sensors' pixels will detect this “event” and it can be counted as a load cycle. Additionally, the duration of the load cycle can be determined by measuring the timestamp between the first even and last event detected.

As indicated above, the characteristics determined from the images of the image stream 131 may be used to predict the future state (status, condition) of the object. For example, the processing circuitry 120 may be configured to predict at least one of a development of the crack and a failure of the object based on dimensions of the crack and the number of load cycles to which the object has been subjected. The dimensions of the crack and the number of load cycles are determined by the processing circuitry 120 based on the image stream 131 as described above.

Each load cycle effects the integrity of the object 190. For example, every time that the object 190 is loaded and unloaded (a single load cycle), the crack will likely propagate further. Similarly, the dimensions of the crack effect the integrity of the object 190. The bigger the crack gets, the higher is the chance that the object 190 will lose integrity and fail.

The propagation of the crack is usually not linear and depends on several factors, such as the rate and force of the loading, material structure, stress distribution and part geometry. Similarly, loading situations can vary and need not be rhythmic or symmetric. Both aspects may complicate the prediction of the development of the crack and the failure of the object 190. In order to account for this, the processing circuitry 120 may be configured to predict the at least one of the development of the crack and the failure of the object using a trained machine-learning model. In particular, the trained machine-learning model may allow determination of and detection of cases of premature failure, in which case the apparatus 100 may be deployed to monitor the object 190 throughout its lifetime.

The machine-learning model is a data structure and/or set of rules representing a statistical model that the processing circuitry 120 uses to predict the at least one of the development of the crack and the failure of the object 190 without using explicit instructions, instead relying on models and inference. The data structure and/or set of rules represents learned knowledge (e.g. based on training performed by a machine-learning algorithm as described below). In machine-learning, instead of a rule-based transformation of data, a transformation of data may be used, that is inferred from an analysis of training data.

The machine-learning model is trained by a machine-learning algorithm. The term “machine-learning algorithm” denotes a set of instructions that are used to create, train or use a machine-learning model. For the machine-learning model to determine the development of the crack and/or the failure of the object 190, the machine-learning model may be trained using training data such as known dimensions of the crack or load cycle counts as input and future dimensions of the crack and/or failure times of the object 190 as target output. In some examples, training data of other objects may be used in addition to or instead of the training data for the object 190 together with future dimensions of the crack and/or failure times of the other objects to train a (more) generic machine-learning model, which may allow earlier predictions. By training the machine-learning model with a large set of training data and associated training content information, the machine-learning model “learns” to determine how the crack grows and when the object 190 fails in the training data, so that a target determination how the crack grows and when the object 190 fails is obtained using the machine-learning model. By training the machine-learning model using training information on dimensions of the crack or load cycle counts and predefined or measured future dimensions of the crack and/or failure times of object, the machine-learning model “learns” a transformation between the input training data and the desired output, which can be used to provide an output based on non-training characteristics of the object 190 provided to the machine-learning model.

The machine-learning model may be trained using training input data (e.g. known dimensions of the crack and/or known load cycle counts). For example, the machine-learning model may be trained using a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. For example, a training sample may comprise known dimensions of the crack and/or known load cycle counts as input data and given (known) future dimensions of the crack and/or failure times of the object as desired output data.

Apart from supervised learning, semi-supervised learning may be used. In semi-supervised learning, some of the training samples lack a corresponding desired output value. Supervised learning may be based on a supervised learning algorithm (e.g. a classification algorithm or a similarity learning algorithm). Classification algorithms may be used as the desired outputs of the trained machine-learning model are restricted to a limited set of values (categorical variables), i.e., the input is classified to one of the limited set of values (e.g., crack is growing, crack does not grow). Similarity learning algorithms are similar to classification algorithms but are based on learning from examples using a similarity function that measures how similar or related two objects are.

Apart from supervised or semi-supervised learning, unsupervised learning may be used to train the machine-learning model. In unsupervised learning, (only) input data are supplied and an unsupervised learning algorithm is used to find structure in the input data such as training physical properties of the user (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters. The input data for the unsupervised learning may be known dimensions of the crack and/or known load cycle counts.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards). A specific, non-limiting example for training the machine-learning model based on reinforcement learning will be described later.

Furthermore, additional techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

For example, the machine-learning model may be an Artificial Neural Network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values (e.g., measured dimensions of the crack and/or the load cycle count), hidden nodes that are (only) connected to other nodes, and output nodes that provide output values (e.g., future dimensions of the crack, a failure time of the object 190, load cycles left until failure of the object 190). Each node may represent an artificial neuron. Each edge may transmit information from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an ANN may comprise adjusting the weights of the nodes and/or edges of the ANN, i.e., to achieve a desired output for a given input.

Alternatively, the machine-learning model may comprise a different structure and, e.g., be a support vector machine, a random forest model or a gradient boosting model. Alternatively, the machine-learning model may be based on a genetic algorithm, which is a search algorithm and heuristic technique that mimics the process of natural selection.

In some examples, the machine-learning model may be a combination of the above examples.

The training of the machine-learning model allows recording and learning of the mechanics of crack propagation and leveraging of this knowledge for fatigue analysis such that the exact time and location of the failure can be predicted. In other words, the combination of an accurate real-time (and, e.g., constantly updating) fatigue and crack model together with counting of each load cycle, the exact condition and time and manner of failure of the object 190 may be predicted. Similarly, development of the crack may be predicted exactly.

Optionally, the processing circuitry 120 may be configured to further train the trained machine-learning model based on a difference between the dimensions of the crack determined by the processing circuitry 120 based on the image stream 131 and a prediction of the development of the crack by the trained machine-learning model. The dimensions of the crack determined by the processing circuitry 120 based on the image stream 131 are used as a ground-truth for the trained machine-learning model to further refine the predictions of the trained machine-learning model. For example, one or more weights of the trained machine-learning model may be updated based on the difference between the dimensions of the crack determined by the processing circuitry 120 based on the image stream 131 and the prediction of the development of the crack by the trained machine-learning model.

The predictions of the trained machine-learning model may further be used for the crack monitoring. For example, the processing circuitry may be further configured to determine whether the crack is growing based on a comparison of images of the image stream (as described above) and using a prediction of the development of the crack. For example, if the trained machine-learning model predicts growth of the crack in a certain spatial direction and/or growth of the crack to a certain extent, this information may be used by the processing circuitry 120 to define one or more areas of the images in the image stream 131 which would be affected by the predicted growth of the crack. Accordingly, the processing circuitry 120 may specifically search in these areas for pixels or pixel structures indicating measurement of a respective event by the corresponding sensor pixels.

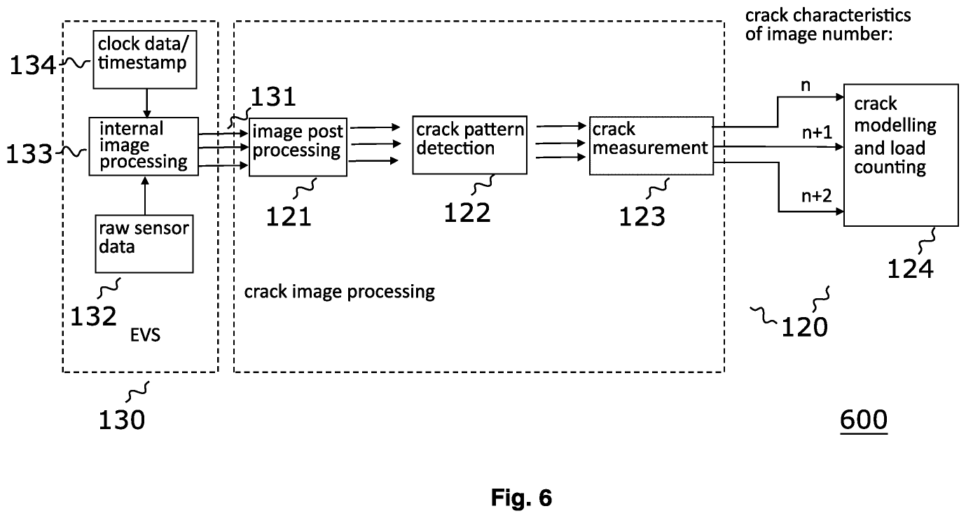

FIG. 6 illustrates a first exemplary data flow 600 for object characterization according to at least some of the aspects described above. The event-based vision sensor 130 sends raw data 132 to its internal image processing 133 and the internal clock allocates a timestamp 134 to the image.

The image stream 131 comprises the images with the metadata. Image post-processing 121 is performed by the processing circuitry to prepare the images of the image stream for crack detection 122. This can involve any method or approach to improve the image quality for the application such as filtering, noise reduction, up-sampling, cropping and anti-aliasing. The processed images are then run through crack pattern detection 122. Crack pattern detection can use simple methods, such as continues connected pixels as described above, or can include computer vision algorithms and libraries (such as OpenCV) as described above. After that, the crack is be measured and characterized by performing crack measurement processing 123 on the processed images. The crack characteristics determined from the individual images of the image stream 131 are then input in the crack and load counting model 124 (i.e., a trained machine-learning model). For example, the crack dimensions and load count may be inputs to the model 124. As described above, with every time step the crack is monitored, if there is a change in the image, it can be deduced that the crack is growing and that a load cycle is in progress. With this the load cycles can be counted.

An output of the model can go to the crack pattern detection 122 and, e.g., indicate locations on the object' surface for which formation of a crack is expected. The crack pattern detection 122 may then search the image of the image stream 131 in the corresponding areas.

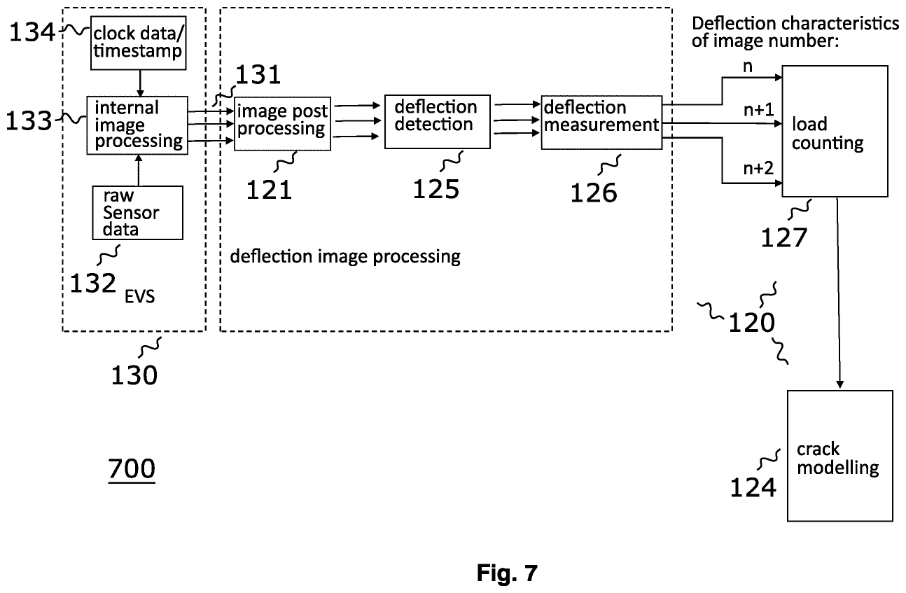

FIG. 7 illustrates a second exemplary data flow 700 for object characterization according to at least some of the aspects described above. Like in the data flow 600, the event-based vision sensor 130 sends raw data 132 to the internal image processing 133 and the internal clock allocates a timestamp 134 to the image. The image stream 131 comprises the images with the metadata. Image post-processing 121 is performed by the processing circuitry 120 to prepare the images of the image stream for deflection detection 125.

After that, the deflection is be measured and characterized by performing deflection measurement processing 126 on the processed images. For example, a duration of the deflection or an extent of the deflection may be determined from the images of the image stream 131. The crack characteristics determined from the individual images of the image stream 131 are the input to load counting processing 127 for counting the number of load cycles to which the object has been subjected.

The number of load cycles to which the object has been subjected may be input to the model 124 as described above to predict crack growth and object failure.

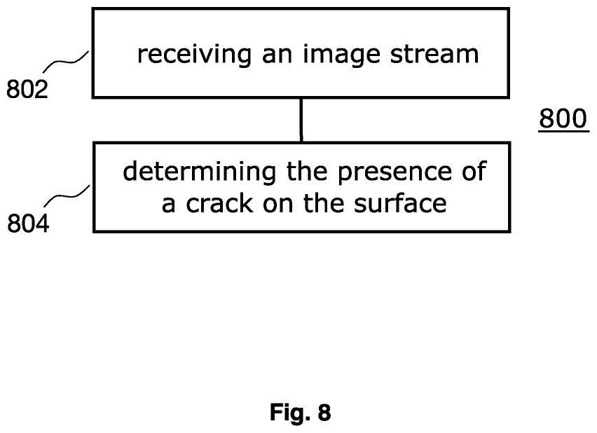

For further highlighting the object characterization described above, FIG. 8 illustrates a flowchart of a method 800 for characterizing an object. The method 800 comprises receiving 802 an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. In addition, the method 800 comprises determining 804 the presence of a crack on the surface of the object based on the image stream.

Analogously to what is described above, the method 800 may allow substantially real-time monitoring of the object due to the extremely high detection rate of the event-based vision sensor. Furthermore, the method 800 may allow monitoring of occluding cracks.

More details and aspects of the method 800 are explained in connection with the proposed technique or one or more examples described above (e.g., FIG. 1 to FIG. 7). The method 800 may comprise one or more additional optional features corresponding to one or more aspects of the proposed technique or one or more examples described above. For example, the method 800 may comprise determining one or more of the crack characteristics described above if it is determined that a crack is present on the surface of the object.

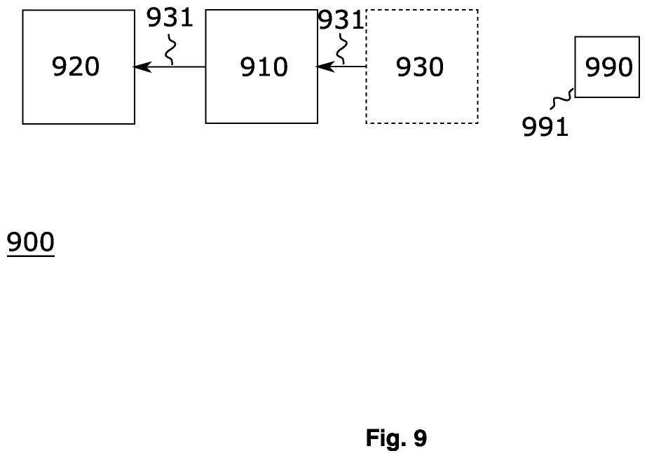

As described above, the load counting based on the deflection of the object may be performed independently from the crack monitoring. For further highlighting this aspect, FIG. 9 schematically illustrates another apparatus 900 for characterizing an object 990. The object 990 is like the object 190 described above.

The apparatus 900 comprises interface circuitry 910 configured to receive an image stream 931 of an event-based vision sensor 930. The event-based vision sensor 930 is like the event-based vision sensor 130 described above and captures the object 990. Accordingly, the image stream 931 comprises a plurality of images for consecutive time instants during the capture of the surface 991 of the object 990. The images of the image stream 931 each comprise a plurality of image pixels indicating whether a corresponding sensor pixel of the event-based vision sensor 930 measured an event for the respective time instant.

Furthermore, the apparatus 900 comprises processing circuitry 920 configured to determine whether a deflection of the object 990 occurred based on the image stream 931. The processing circuitry 920 is like the processing circuitry 120 described above. The processing circuitry 920 determines whether a deflection of the object 990 occurred based on the image stream 931 analogously to what is described above for the processing circuitry 120.

If it is determined that a deflection of the object occurred, the processing circuitry 920 is configured to increment a counter for counting a number of load cycles to which the object 990 has been subjected.

Analogously to what is described above for the object 190, the number of load cycles to which the object 990 has been subjected is a quantity that may allow to predict the failure of the object 990. Due to the extremely high detection rate of the event-based vision sensor 930, the apparatus 900 may allow substantially real-time monitoring of the object's deflection. In particular, the apparatus 900 may allow to reliably determine deflections of the object 990 in case the object 990 is subject to cyclic loading at high frequency.

The processing circuitry 120 may optionally further determine one or more characteristics of the deflection such as a duration of the deflection. The duration of the deflection may be determined as described above for the deflection of the object 190. That is, the processing circuitry 920 may be configured to select the image of the image stream 931 having the earliest timestamp from a plurality of images identified as images representing the deformation and select the image of the image stream 931 having the latest timestamp from the plurality of images identified as images representing the deformation. The processing circuitry 920 may be configured to determine the difference between the image having the lates timestamp and the image having the earliest timestamp as the duration of the deflection. The duration of the deflection may allow to learn about the reaction of the object 990 to the loading and may further allow to characterize the loading process.

Analogously to what is described above for the object 190, the processing circuitry 920 may further be configured to predict a failure of the object 990 using a trained machine-learning model. The trained machine-learning model receives as input at least the number of load cycles to which the object 990 has been subjected. The machine-learning model be trained as described herein. In particular, the trained machine-learning may be the same as described above with respect to the apparatus 100. As described above, the trained machine-learning model may allow accurate prediction of a failure of the object 990.

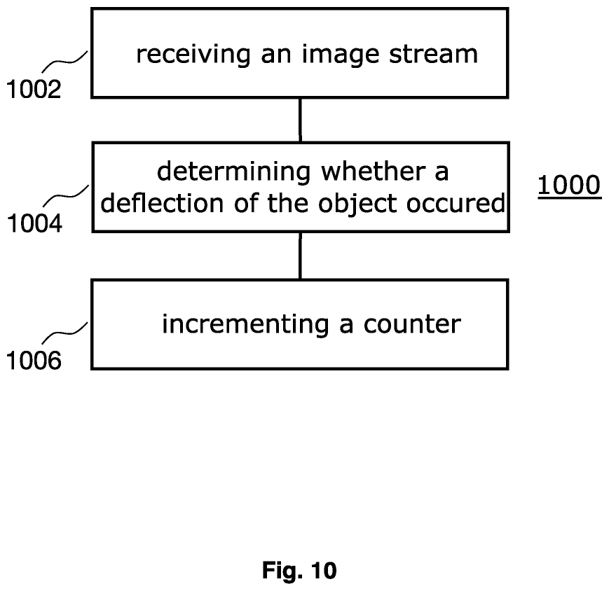

FIG. 10 illustrates a flowchart of a corresponding method 1000 for characterizing an object. The method 1000 comprises receiving 1002 an image stream of an event-based vision sensor. The image stream comprises a plurality of images for consecutive time instants during the capture of a surface of the object. The images of the image stream each comprise a plurality of image pixels indicating whether a corresponding sensor pixel of the event-based vision sensor measured an event for the respective time instant. Additionally, the method 1000 comprises determining 1004 whether a deflection of the object occurred based on the image stream. If it is determined that a deflection of the object occurred, the method 1000 further comprises incrementing 1006 a counter for counting a number of load cycles to which the object has been subjected.

Analogously to what is described above, the method 1000 may allow substantially real-time deflection monitoring of the object due to the extremely high detection rate of the event-based vision sensor.

More details and aspects of the method 1000 are explained in connection with the proposed technique or one or more examples described above (e.g., FIG. 1 to FIG. 9). The method 1000 may comprise one or more additional optional features corresponding to one or more aspects of the proposed technique or one or more examples described above. For example, if it is determined that no deflection of the object occurred, the method 1000 may further comprise not incrementing the counter.

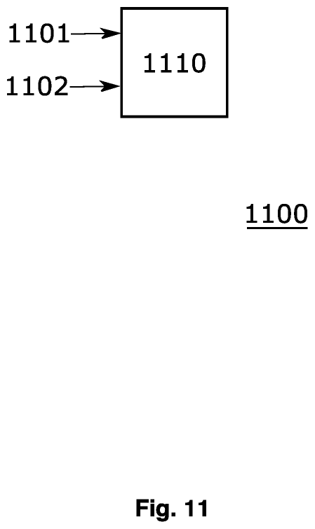

As described above, the machine-learning model for predicting the development of the crack on the surface 191 of the object 190 and the failure of the object 190 may be trained using various training techniques. In the following, a non-limiting training approach based on reinforcement learning is described with reference to FIG. 11. FIG. 11 schematically illustrates an apparatus 1100 for training a machine-learning model for predicting a development of a crack on a surface of an object and a failure of the object. The apparatus comprises processing circuitry 1110. The processing circuitry 1110 may be like the processing circuitry 120 described above.

The processing circuitry 1110 is configured to determine, based on an image stream 1101 of an event-based vision sensor, a characteristic describing the development of the crack for a time instant. The image stream 1101 may be like the image stream 131 described above. The characteristic describing the development of the crack for the time instant may, e.g., be dimensions of the crack at the time instant or a change in the dimensions of the crack since a previous time instant as described above. However, also other crack characteristics may be used.

The processing circuitry 1110 is further configured to determine a difference between the determined characteristic and a prediction 1102 of the machine-learning model about the development of the crack for the time instant. For example, if the determined characteristics is dimensions of the crack at the time instant, it may be compared to predicted dimensions of the crack for the time instant as output by the machine-learning model.

The processing circuitry 1110 is configured to determine a reward according to a reward function based on the determined difference and to modify the machine-learning model based on the determined reward to maximize the reward.

The above processing by the processing circuitry 1110 may be performed iteratively to gradually train and refine the machine-learning model based on the images of the image stream 1101 and predictions of the machine-learning model for consecutive time instants.

The apparatus 1100 may allow one to obtain a trained machine-learning model for predicting the development of the crack on the surface of an object and the failure of the object. For example, the apparatus 1100 may be used to train the machine-learning model used in the above examples for predicting the development of the crack on the surface 191 of the object 190 and the failure of the object 190.

The processing circuitry 1110 acts as agent for training the machine-learning model. In other words, a machine-learning model is given to an agent and the agent monitors the environment by analyzing the image stream 1101 of an event-based vision sensor. If the machine-learning model correctly predicts the next time step in the environment, then the agent is rewarded according to the reward function. Likewise, the agent if the agent fails, no reward is given. The aim is to maximize the reward by exploiting the image stream 1101 previously recorded images of the image stream 1101 as well as future images of the image stream 1101 to further train the machine-learning model.

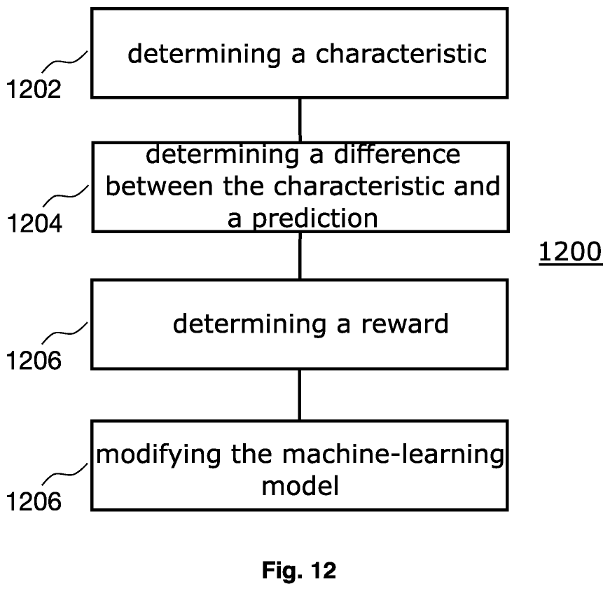

FIG. 12 illustrates a flowchart of a corresponding method 1200 for training a machine-learning model for predicting a development of a crack on a surface of an object and a failure of the object. The method 1200 comprises determining 1202, based on an image stream of an event-based vision sensor, a characteristic describing the development of the crack for a time instant. In addition, the method 1200 comprises determining 1204 a difference between the determined characteristic and a prediction of the machine-learning model about the development of the crack for the time instant. The method 1200 comprises determining 1206 a reward according to a reward function based on the determined difference. Further, the method 1200 comprises modifying 1208 the machine-learning model based on the determined reward to maximize the reward.

Analogously to what is described above, the method 1200 may allow one to obtain a trained machine-learning model for predicting the development of the crack on the surface of an object and the failure of the object

More details and aspects of the method 1200 are explained in connection with the proposed technique or one or more examples described above (e.g., FIG. 1 to FIG. 11). The method 1200 may comprise one or more additional optional features corresponding to one or more aspects of the proposed technique or one or more examples described above.

The proposed apparatuses and methods may be used over large distances, for example measuring the deflection of portions of a bridge from a position on-land far from the bridge. Also, no wiring is required, as in traditional strain gauges, which require wiring that have a practical limit of a few meters only.

Furthermore, the proposed apparatuses and methods may be used in hazardous or corrosive environments. The proposed apparatuses and methods additionally function independently from temperature and pressure fluctuations. If required, two cameras placed perpendicular to one another may be used to compensate for thermal expansion. In addition, the proposed apparatuses and methods do not require a perfect flat and orthogonal surface like a strain gauge glued to the stressed member. Also as there is no dependence of the quality of the bonding to the member such that uncertainty in the measurement is reduced.

To account for varying lighting conditions, which might be detected as events by the event-based vision sensor be possibly misinterpreted as deflections, various solutions are possible. For example, a laser beam or any other known and defined type of light may be directed to the surface of the object (e.g., at a point of interest on the surface) and the event-based vision sensor may use one or more filters configuring the event-based vision sensor to only react to narrow wavelength of the laser light. Then all other light sources and disturbances would be ignored by the proposed apparatuses and methods.

The event-based vision sensor may be kept static relative to the object according to some examples. If a relative static positioning cannot be guaranteed, a triangulation setup with three event-based vision sensors may be used to calculate the relative positions.

As indicated above, the proposed apparatuses and methods may provide non-contact event-based stain and fatigue analysis and simplified deployment when compared to strain gauges. Furthermore, the proposed apparatuses and methods may be deployed over large distances, hazardous environment and with complex geometry. The proposed apparatuses and methods provide an event driven crack identification and monitoring.

The following examples pertain to further embodiments:
(1) An apparatus for characterizing an object, the apparatus comprising:
interface circuitry configured to receive an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
processing circuitry configured to determine the presence of a crack on the surface of the object based on the image stream.
(2) The apparatus of (1), wherein the processing circuitry is configured to determine that a crack is present on the surface of the object if an image of the image stream comprises a plurality of pixels which succeed each other along a spatial direction and which indicate measurement of a respective event by the corresponding sensor pixels.
(3) The apparatus of (1) or (2), wherein, if it is determined that a crack is present on the surface of the object, the processing circuitry is further configured to determine at least one of a time of occurrence of an initiation point of the crack and a location of the initiation point on the surface based on the image stream.
(4) The apparatus of (3), wherein, for determining the time of occurrence of the initiation point of the crack, the processing circuitry is configured to:
determine a plurality of pixel positions representing the crack in the first image of the image stream for which it is determined that a crack is present on the surface of the object;
determine one or more images preceding the first image in the image stream and depicting the crack, wherein an image preceding the first image in the image stream is determined to depict the crack if the image comprises, for at least one of the plurality of determined pixel positions representing the crack, a respective pixel indicating measurement of a respective event by the corresponding sensor pixel;
select the image having the earliest timestamp from the determined one or more images pre-ceding the first image in the image stream and depicting the crack; and
determine the time indicated by the timestamp of the selected image as the time of occurrence of the initiation point of the crack.
(5) The apparatus of (3) or (4), wherein, for determining the location of the initiation point of the crack on the surface, the processing circuitry is configured to:
determine a plurality of pixel positions representing the crack in the first image of the image stream for which it is determined that a crack is present on the surface of the object;
determine one or more images preceding the first image in the image stream and depicting the crack, wherein an image preceding the first image in the image stream is determined to depict the crack if the image comprises, for at least one of the plurality of determined pixel positions representing the crack, a respective pixel indicating measurement of a respective event by the corresponding sensor pixel;
select the image having the earliest timestamp from the determined one or more images pre-ceding the first image in the image stream and depicting the crack;
determine the one or more pixel positions of the plurality of determined pixel positions representing the crack for which the selected image comprises a respective pixel indicating measurement of a respective event by the corresponding sensor pixel as pixel positions representing the initiation point of the crack on the surface; and
determine a location of the surface represented by the one or more pixel positions representing the initiation point of the crack on the surface as the location of the initiation point of the crack on the surface.
(6) The apparatus of any one of (1) to (5), wherein, if it is determined that a crack is present on the surface of the object, the processing circuitry is further configured to determine dimensions of the crack based on the image stream.
(7) The apparatus of (6), wherein the interface circuitry is further configured to receive another image stream of another event-based vision sensor, wherein the other image stream comprises a plurality of other images for consecutive time instants during the capture of the object, wherein the images of the other image stream each comprise a plurality of image pixels indicating whether a corresponding sensor pixel of the other event-based vision sensor measured an event for the respective time instant, and wherein the processing circuitry is configured to:
determine the dimensions of the crack in a first plane based on the image stream,
determine dimensions of the crack in a second plane based on the other image stream; and
determine three-dimensional dimensions of the crack based on the determined dimensions of the crack in the first plane and the second plane.
(8) The apparatus of (7), further comprising:
the event-based vision sensor, wherein the event-based vision sensor is configured to capture the surface of the object; and
the other event-based vision sensor, wherein the event-based vision sensor and the other event-based vision sensor are configured to capture the object from different directions.
(9) The apparatus of any one of (1) to (8), wherein, if it is determined that a crack is present on the surface of the object, the processing circuitry is further configured to determine whether the crack is growing based on a comparison of images of the image stream.
(10) The apparatus of (9), wherein, if it is determined that the crack is growing, the processing circuitry is further configured to increment a counter for counting a number of load cycles to which the object has been subjected.
(11) The apparatus of any one of (1) to (10), wherein processing circuitry is further configured to:
determine whether a deflection of the object occurred based on the image stream; and
if it is determined that a deflection of the object occurred, increment a counter for counting a number of load cycles to which the object has been subjected.
(12) The apparatus of (11), wherein the processing circuitry is further configured to determine a duration of the deflection by:
selecting the image having the earliest timestamp from a plurality of images identified as images representing the deformation;
selecting the image having the latest timestamp from the plurality of images identified as images representing the deformation; and
determining the difference between the image having the latest timestamp and the image having the earliest timestamp as the duration of the deflection.
(13) The apparatus of any one of claims (1) to (12), wherein the processing circuitry is further configured to predict at least one of a development of the crack and a failure of the object based on dimensions of the crack and a number of load cycles to which the object has been subjected, the dimensions of the crack and the number of load cycles being determined by the processing circuitry based on the image stream.
(14) The apparatus of (13), wherein the processing circuitry is configured to predict the at least one of the development of the crack and the failure of the object using a trained machine-learning model.
(15) The apparatus of (14), wherein the processing circuitry is configured to further train the trained machine-learning model based on a difference between the dimensions of the crack determined by the processing circuitry based on the image stream and a prediction of the development of the crack by the trained machine-learning model.
(16) The apparatus of any one of (13) to (15), wherein, if it is determined that a crack is present on the surface of the object, the processing circuitry is further configured to determine whether the crack is growing based on a comparison of images of the image stream and using a prediction of the development of the crack.
(17) The apparatus of any one of (1) to (16), further comprising the event-based vision sensor, wherein the event-based vision sensor is configured to capture the surface of the object.
(18) The apparatus of (8) or (17), wherein the event-based vision sensor is configured to capture the surface of the object at an angle of 90°.
(19) A method for characterizing an object, the method comprising:
receiving an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
determining the presence of a crack on the surface of the object based on the image stream.
(20) An apparatus for characterizing an object, the apparatus comprising:
interface circuitry configured to receive an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
processing circuitry configured to:
determine whether a deflection of the object occurred based on the image stream; and
if it is determined that a deflection of the object occurred, increment a counter for counting a number of load cycles to which the object has been subjected.
(21) The apparatus of (20), wherein the processing circuitry is further configured to determine a duration of the deflection by:
selecting the image having the earliest timestamp from a plurality of images identified as images representing the deformation;
selecting the image having the latest timestamp from the plurality of images identified as images representing the deformation; and
determining the difference between the image having the lates timestamp and the image having the earliest timestamp as the duration of the deflection.
(22) The apparatus of (20) or (21), wherein the processing circuitry is further configured to predict a failure of the object using a trained machine-learning model, wherein the trained machine-learning model receives as input at least the number of load cycles to which the object has been subjected.
(23) A method for characterizing an object, the apparatus comprising:
receiving an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant;
determining whether a deflection of the object occurred based on the image stream; and
if it is determined that a deflection of the object occurred, incrementing a counter for counting a number of load cycles to which the object has been subjected.
(24) An apparatus for training a machine-learning model for predicting a development of a crack on a surface of an object and a failure of the object, the apparatus comprising processing circuitry configured to:
determine, based on an image stream of an event-based vision sensor, a characteristic describing the development of the crack for a time instant;
determine a difference between the determined characteristic and a prediction of the machine-learning model about the development of the crack for the time instant;
determine a reward according to a reward function based on the determined difference; and modify the machine-learning model based on the determined reward to maximize the reward.
(25) The apparatus of (24), wherein the characteristic describing the development of the crack for the time instant is dimensions of the crack at the time instant or a change in the dimensions of the crack since a previous time instant.
(26) A method for training a machine-learning model for predicting a development of a crack on a surface of an object and a failure of the object, the method comprising:
determining, based on an image stream of an event-based vision sensor, a characteristic describing the development of the crack for a time instant;
determining a difference between the determined characteristic and a prediction of the machine-learning model about the development of the crack for the time instant;
determining a reward according to a reward function based on the determined difference; and
modifying the machine-learning model based on the determined reward to maximize the reward.
(27) A non-transitory machine-readable medium having stored thereon a program having a program code for performing the method according to any one of (19), (23), (25) and (26), when the program is executed on a processor or a programmable hardware.
(28) A program having a program code for performing the method according to any one of (19), (23), (25) and (26), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), ASICs, integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for characterizing an object, the apparatus comprising:
interface circuitry configured to receive an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
processing circuitry configured to determine the presence of a crack on the surface of the object based on the image stream.

2. The apparatus of claim 1, wherein the processing circuitry is configured to determine that a crack is present on the surface of the object if an image of the image stream comprises a plurality of pixels which succeed each other along a spatial direction and which indicate measurement of a respective event by the corresponding sensor pixels.

3. The apparatus of claim 1, wherein, if it is determined that a crack is present on the surface of the object, the processing circuitry is further configured to determine at least one of a time of occurrence of an initiation point of the crack and a location of the initiation point on the surface based on the image stream.

4. The apparatus of claim 3, wherein, for determining the time of occurrence of the initiation point of the crack, the processing circuitry is configured to:
determine a plurality of pixel positions representing the crack in the first image of the image stream for which it is determined that a crack is present on the surface of the object;
determine one or more images preceding the first image in the image stream and depicting the crack, wherein an image preceding the first image in the image stream is determined to depict the crack if the image comprises, for at least one of the plurality of determined pixel positions representing the crack, a respective pixel indicating measurement of a respective event by the corresponding sensor pixel;
select the image having the earliest timestamp from the determined one or more images pre-ceding the first image in the image stream and depicting the crack; and
determine the time indicated by the timestamp of the selected image as the time of occurrence of the initiation point of the crack.

5. The apparatus of claim 3, wherein, for determining the location of the initiation point of the crack on the surface, the processing circuitry is configured to:
determine a plurality of pixel positions representing the crack in the first image of the image stream for which it is determined that a crack is present on the surface of the object;
determine one or more images preceding the first image in the image stream and depicting the crack, wherein an image preceding the first image in the image stream is determined to depict the crack if the image comprises, for at least one of the plurality of determined pixel positions representing the crack, a respective pixel indicating measurement of a respective event by the corresponding sensor pixel;
select the image having the earliest timestamp from the determined one or more images pre-ceding the first image in the image stream and depicting the crack;
determine the one or more pixel positions of the plurality of determined pixel positions representing the crack for which the selected image comprises a respective pixel indicating measurement of a respective event by the corresponding sensor pixel as pixel positions representing the initiation point of the crack on the surface; and
determine a location of the surface represented by the one or more pixel positions representing the initiation point of the crack on the surface as the location of the initiation point of the crack on the surface.

6. The apparatus of claim 1, wherein, if it is determined that a crack is present on the surface of the object, the processing circuitry is further configured to determine dimensions of the crack based on the image stream.

7. The apparatus of claim 6, wherein the interface circuitry is further configured to receive another image stream of another event-based vision sensor, wherein the other image stream comprises a plurality of other images for consecutive time instants during the capture of the object, wherein the images of the other image stream each comprise a plurality of image pixels indicating whether a corresponding sensor pixel of the other event-based vision sensor measured an event for the respective time instant, and wherein the processing circuitry is configured to:
determine the dimensions of the crack in a first plane based on the image stream,
determine dimensions of the crack in a second plane based on the other image stream; and
determine three-dimensional dimensions of the crack based on the determined dimensions of the crack in the first plane and the second plane.

8. The apparatus of claim 7, further comprising:
the event-based vision sensor, wherein the event-based vision sensor is configured to capture the surface of the object; and
the other event-based vision sensor, wherein the event-based vision sensor and the other event-based vision sensor are configured to capture the object from different directions.

9. The apparatus of claim 1, wherein, if it is determined that a crack is present on the surface of the object, the processing circuitry is further configured to determine whether the crack is growing based on a comparison of images of the image stream.

10. The apparatus of claim 9, wherein, if it is determined that the crack is growing, the processing circuitry is further configured to increment a counter for counting a number of load cycles to which the object has been subjected.

11. The apparatus of claim 1, wherein processing circuitry is further configured to:
determine whether a deflection of the object occurred based on the image stream; and
if it is determined that a deflection of the object occurred, increment a counter for counting a number of load cycles to which the object has been subjected.

12. The apparatus of claim 11, wherein the processing circuitry is further configured to determine a duration of the deflection by:
selecting the image having the earliest timestamp from a plurality of images identified as images representing the deformation;
selecting the image having the latest timestamp from the plurality of images identified as images representing the deformation; and
determining the difference between the image having the latest timestamp and the image having the earliest timestamp as the duration of the deflection.

13. The apparatus of claim 1, wherein the processing circuitry is further configured to predict at least one of a development of the crack and a failure of the object based on dimensions of the crack and a number of load cycles to which the object has been subjected, the dimensions of the crack and the number of load cycles being determined by the processing circuitry based on the image stream.

14. The apparatus of claim 13, wherein the processing circuitry is configured to predict the at least one of the development of the crack and the failure of the object using a trained machine-learning model.

15. The apparatus of claim 14, wherein the processing circuitry is configured to further train the trained machine-learning model based on a difference between the dimensions of the crack determined by the processing circuitry based on the image stream and a prediction of the development of the crack by the trained machine-learning model.

16. The apparatus of claim 13, wherein, if it is determined that a crack is present on the surface of the object, the processing circuitry is further configured to determine whether the crack is growing based on a comparison of images of the image stream and using a prediction of the development of the crack.

17. The apparatus of claim 1, further comprising the event-based vision sensor, wherein the event-based vision sensor is configured to capture the surface of the object.

18. The apparatus of claim 17, wherein the event-based vision sensor is configured to capture the surface of the object at an angle of 90°.

19. A method for characterizing an object, the method comprising:
receiving an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
determining the presence of a crack on the surface of the object based on the image stream.

20. An apparatus for characterizing an object, the apparatus comprising:
interface circuitry configured to receive an image stream of an event-based vision sensor, wherein the image stream comprises a plurality of images for consecutive time instants during the capture of a surface of the object, wherein the images of the image stream each comprise a plurality of image pixels indicating whether a corresponding sensor pixel of the event-based vision sensor measured an event for the respective time instant; and
processing circuitry configured to:
determine whether a deflection of the object occurred based on the image stream; and
if it is determined that a deflection of the object occurred, increment a counter for counting a number of load cycles to which the object has been subjected.
